(19) United States
(12) Patent Application Publication
(10) Pub. No.: US 2010/0080000 A1
(43) Pub. Date: Apr. 1, 2010

(54) LASER DIODE DEVICE AND DISPLAY APPARATUS

(75) Inventors: Daijiro INOUE, Kyoto-shi (JP); Yasuyuki BESSHO, Uji-shi (JP); Masayuki HATA, Kadoma-shi (JP)

Correspondence Address: MOTS LAW, PLLC, Suite 602, 1629 K Street, N.W., Washington, DC, 20006, US

(73) Assignee: SANYO ELECTRIC CO., LTD., Osaka (JP)

(21) Appl. No.: 12/565,670

(22) Filed: Sep. 23, 2009

(30) Foreign Application Priority Data
Sep. 26, 2008 (JP) 2008-248927
Aug. 25, 2009 (JP) 2009-193795

(51) Int. Cl. G02B 27/18; H01S 3/23; H01S 3/04

(52) U.S. Cl. 362/259; 372/38.04; 372/34; 372/43.01

(57) ABSTRACT

A laser diode device includes a red laser diode element, a green laser diode element and a blue laser diode element. The red, green and blue laser diode elements are arranged in a single package in a state of being connected to wires for supplying power independently. Additionally, the blue laser diode element is arranged between the red laser diode element and the green laser diode element as viewed from a laser beam-emitting direction.

### CROSS-REFERENCE TO RELATED APPLICATIONS

The priority application numbers JP2008-248927, Laser Diode Device, Sep. 26, 2008, Daijiro Inoue et al., JP2009-193795, Laser Diode Device and Display Apparatus, Aug. 25, 2009, Daijiro Inoue et al., upon which this patent application is based are hereby incorporated by reference.

### BACKGROUND OF THE INVENTION

1. Field of the Invention

The present invention relates to a laser diode device and a display apparatus, and more particularly, it relates to a laser diode device comprising a red laser diode element, a green laser diode element and a blue laser diode element and a display apparatus comprising the same.

2. Description of the Background Art

A laser diode device comprising a red laser diode element, a green laser diode element, a blue laser diode element is known in general as disclosed in Japanese Patent Laying-Open No. 2006-186243, for example.

In the aforementioned laser light source (laser diode device) described in Japanese Patent Laying-Open No. 2006-186243, the red, green and blue laser diode elements are arranged in this order with prescribed intervals in a plane on a surface of a single support base (heat radiation substrate) bonded to a single package (stem). In other words, the red and green laser diode elements are arranged to be adjacent to each other. The red, green and blue laser diode elements are bonded to by solder the support base covered by a conductive metal layer in a junction-down system.

Luminous efficiency (energy conversion efficiency) of the green laser diode element is low, and hence larger power must be supplied to the green laser diode element than the red and blue laser diode elements in order that the green laser diode element obtains luminous intensity similar to those of the red and blue laser diode elements. Therefore, the amount of generated heat in the green laser diode element is larger than those in red and blue laser diode elements when driving the laser diode device.

On the other hand, the red laser diode element having a long lasing wavelength is made of a material with a smaller band gap than the blue and green laser diode elements having short lasing wavelengths. Thus, in the red laser diode element, increase of a threshold current with rising temperature is larger than those in the blue and green laser diode elements. Therefore, in the red laser diode element, increase of an operation current caused by increase of the threshold current is larger than the those in the blue and green laser diode elements, and hence lasing characteristics are further deteriorated due to rising temperature.

In the aforementioned laser light source disclosed in the Japanese Patent Laying-Open No. 2006-186243, however, the red laser diode element is bonded to the surface of the single support base so as to be adjacent to the green laser diode element, whereby heat is transmitted from the green laser diode element where the large amount of heat is generated to the red laser diode element through the support base when the both substantially simultaneously lase or alternately lase in time series. Thus, the operation current of the red laser diode element is increased with rising temperature of the red laser diode element when driving the laser light source. Therefore, lasing characteristics of the red laser diode element are disadvantageously deteriorated.

### SUMMARY OF THE INVENTION

A laser diode device according to a first aspect of the present invention comprises a red laser diode element, a green laser diode element and a blue laser diode element, wherein the red, green and blue laser diode elements are arranged in a package in a state of being independently connected to first, second and third wires for supplying power, respectively, and the blue laser diode element is arranged between the red laser diode element and the green laser diode element as viewed from a laser beam-emitting direction.

In the laser diode device according to the first aspect of the present invention, as hereinabove described, the blue laser diode element is arranged between the red and green laser diode elements, whereby it is possible to reduce transmission of heat from the green laser diode element where the large amount of heat is generated to the red laser diode element and hence deterioration of lasing characteristics resulting from rising temperature of the red laser diode element in operation of the laser diode device can be suppressed. Each of the red, green and blue laser diode element is arranged in the state of being connected to the wires for supplying power independently, whereby heat generated in the respective laser elements can be radiated through the wires individually connected to the respective laser elements. Accordingly, this also suppresses deterioration of lasing characteristics resulting from rising of the temperature of the red laser diode element during operation of the laser diode device.

In the aforementioned laser diode device according to the first aspect, the red laser diode element is preferably formed on a GaAs substrate, and the green and blue laser diode elements are preferably made of materials containing nitride-based semiconductors. According to this structure, the red, green and blue laser diode elements constituting the laser diode device of the present invention can be easily formed.

In the aforementioned laser diode device according to the first aspect, the package preferably has a support base arranged with the red, green and blue laser diode elements. According to this structure, heat generated in the respective red, blue and green laser diode elements can be radiated outside by the support base.

In this case, the red laser diode element has a first light-emitting portion formed on a near side of the red laser diode element to the support base. According to this structure, heat generated around the first light-emitting portion of the red laser diode element can be easily radiated from the support base provided in the vicinity of the first light-emitting portion of the red laser diode element, and hence deterioration of lasing characteristics resulting from rising temperature of the red laser diode element during operation of the laser diode device 100 can be suppressed.

The aforementioned laser diode device in which the package has the support base further comprises a first heat radiation substrate arranged between the red laser diode element and the support base, and at least one second heat radiation substrate arranged between the green laser diode element and the support base and between the blue laser diode element and the support base, wherein the first heat radiation substrate is separated from the second heat radiation substrate. According to this structure, it is possible to reduce transmission of heat from the green and blue laser diode elements to the red laser diode element through the second and first heat radiation substrates. Additionally, heat generated in the red laser diode element can be radiated through the first heat radiation substrate and heat generated in the green and blue laser diode elements can be radiated through the second heat radiation substrate. Thus, deterioration of lasing characteristics resulting from rising temperature of the red laser diode element during operation of the laser diode device can be further suppressed.

In this case, thermal conductivity of the first heat radiation substrate is preferably higher than thermal conductivity of the second heat radiation substrate. According to this structure, heat can be efficiently radiated on the red laser diode element to the support base through the first heat radiation substrate. It is possible to retard heat transfer from the green and blue laser diode elements to the support base through the second heat radiation substrate. Therefore, it is possible that heat is hard to transmit to the red laser diode element.

In the aforementioned laser diode device in which the first heat radiation substrate is separated from the second heat radiation substrate, the second heat radiation substrate preferably includes a third heat radiation substrate arranged between the green laser diode element and the support base and a fourth heat radiation substrate, separated from the third heat radiation substrate, arranged between the blue laser diode element and the support base. According to this structure, the heat generated in the green laser diode element and the heat generated in the blue laser diode element can be separately radiated through the third heat radiation substrate and the fourth heat radiation substrate, respectively, and hence it is possible that heat is hard to transmit to the red laser diode element.

In the aforementioned laser diode device in which the first heat radiation substrate is separated from the second heat radiation substrate, the support base has a groove between a portion arranged with the first heat radiation substrate and a portion arranged with the second heat radiation substrate. According to this structure, it is possible to further reduce transmission of heat from the green and blue laser diode elements to the red laser diode element by the groove of the support base.

In the aforementioned laser diode device in which the first heat radiation substrate is separated from the second heat radiation substrate, the support base preferably has a first support base arranged with the first heat radiation substrate and a second support base, separated from the first support base, arranged with the second heat radiation substrate. According to this structure, because the first heat radiation substrate is separated from the second heat radiation substrate, and because the first support base arranged with the first heat radiation substrate is also separated from the second support base arranged with the second heat radiation substrate, it is possible to further reduce transmission of heat from the green and blue laser diode elements to the red laser diode element.

In the aforementioned laser diode device in which the package has the support base, the green laser diode element and the blue laser diode element have a second light-emitting portion and a third light-emitting portion, respectively, and the second and third light-emitting portions are formed on near sides of the green and blue laser diode elements to the support base, respectively. According to this structure, heat generated around the second light-emitting portion of the green laser diode element and heat generated around the third light-emitting portion of the blue laser diode element can be easily radiated through the support base located in the vicinity of the second and third light-emitting portions.

In the aforementioned laser diode device in which the first heat radiation substrate is separated from the second heat radiation substrate, the red, green and blue laser diode elements preferably have a first light-emitting portion, a second light-emitting portion and a third light-emitting portion, respectively, and the first light-emitting portion is preferably arranged on a side of the first heat radiation substrate, and the second and third light-emitting portions are arranged on a side of the second heat radiation substrate. According to this structure, heat generated around the first light-emitting portion of the red laser diode element can be easily radiated through the first heat radiation substrate and the support base located in the vicinity of the first light-emitting, and heat generated around the second light-emitting portion of the green laser diode element and heat generated around the third light-emitting portion of the blue laser diode element can be easily radiated through the second heat radiation substrate and the support base located in the vicinity of the second light-emitting portion and the third light-emitting portion.

In the aforementioned laser diode device in which the first heat radiation substrate is separated from the second heat radiation substrate, the package, the first heat radiation substrate and the second heat radiation substrate are preferably conductive. According to this structure, no wire is required for connecting the package and the first electrodes of the red, green and blue laser diode elements, and hence wire distribution in the laser diode device can be inhibited from complication.

In the aforementioned laser diode device in which the package has the support base, the first, second and third wires are connected to respective electrodes of the red, green and blue laser diode elements on an opposite sides of the red, green and blue laser diode elements to the support base. According to this structure, the flexibility of wiring for supplying power can be improved and heat generated in the respective laser diode elements can be radiated from the wires connected to the respective laser diode elements.

In the aforementioned laser diode device according to the first aspect, the green and blue laser diode elements are preferably formed on a surface of the same substrate. According to this structure, the green laser diode element and the blue laser diode element need not separately bonded, and hence an interval between a luminous point of the green laser diode element and a luminous point of the blue laser diode element can be further correctly positioned.

In the aforementioned laser diode device in which the package has the support base, the red and green laser diode elements are arranged in the vicinity of one end of the support base and in the vicinity of the other end of the support base, respectively. According to this structure, an interval between the red and green laser diode elements can be increased, and hence it is possible to further reduce transmission of heat from the green laser diode element where the large amount of heat is generated to the red laser diode element, and deterioration of lasing characteristics resulting from rising temperature of the red laser diode element can be suppressed.

In the aforementioned laser diode device according to the first aspect, a plurality of the red laser diode elements are preferably arranged in the single package so as not to be adjacent to the green laser diode element. According to this structure, it is possible to reduce transmission of heat from the green laser diode element where the large amount of heat is generated to each of the plurality of red laser diode elements arranged so as not to be adjacent to the green laser diode element, and hence deterioration of lasing characteristics resulting from rising temperature of each of the red laser diode elements during operation of the laser diode device can be suppressed.

In the aforementioned laser diode device according to the first aspect, the green and blue laser diode elements preferably have a common first electrode. According to this structure, the green and blue laser diode elements can be operated by connecting the first electrode of the green and blue laser diode elements to a common power supply.

In the aforementioned laser diode device according to the first aspect, the green laser diode element and the blue laser diode element preferably have a second light-emitting portion and a third light-emitting portion formed on an opposite side of respective laser diode elements the support base. According to this structure, the second and third light-emitting portions can be kept away from the heat radiation substrate as compared with a case of arranging the second and third light-emitting portions on the side of the support base, and hence it is possible to further reduce transmission of heat generated around the second and third light-emitting portions to the red laser diode element through the support base.

A laser diode device according to a second aspect of the present invention comprises a red laser diode element having a first light-emitting portion, a green laser diode element having a second light-emitting portion, a blue laser diode element having a third light-emitting portion and a package having a support base arranged with the red, green and blue laser diode elements, wherein the blue laser diode element is arranged between the red laser diode element and the green laser diode element as viewed from a laser beam-emitting direction, and the first light-emitting portion, the second light-emitting portion and the third light-emitting portion are formed on near sides of the red, green and blue laser diode elements to the support base, respectively.

In the laser diode device according to the second aspect of the present invention, as hereinabove described, the blue laser diode element is arranged between the red and green laser diode elements, whereby it is possible to reduce transmission of heat from the green laser diode element where the large amount of heat is generated to the red laser diode element and hence deterioration of lasing characteristics resulting from rising temperature of the red laser diode element during operation of the laser diode device, can be suppressed. The first, second and third light-emitting portions are arranged on the side of the support base, whereby heat generated around the first, second and third light-emitting portions of the red, green and blue laser diode elements can be easily radiated through the support base located in the vicinity of the first, second and third light-emitting portions. Thus, it is possible to reduce transmission of heat from the green and blue laser diode elements to the red laser diode element and heat generated around the first light-emitting portion of the red laser diode element can be radiated to the support base. Accordingly, this also can suppress deterioration of lasing characteristics resulting from rising temperature of the red laser diode element during operation of the laser diode device.

In the aforementioned laser diode device according to the second aspect preferably further comprises a first heat radiation substrate arranged between the red laser diode element and the support base, and at least one second heat radiation substrate arranged between the green laser diode element and the support base, and between the blue laser diode element and the support base, wherein the first heat radiation substrate is separated from the second heat radiation substrate. According to this structure, it is possible to reduce transmission of heat from the green and blue laser diode elements to the red laser diode element through the second and first heat radiation substrates. Additionally, heat generated in the red laser diode element can be radiated through the first heat radiation substrate and heat generated in the green and blue laser diode elements can be radiated through the second heat radiation substrate. Thus, deterioration of lasing characteristics resulting from rising temperature of the red laser diode element during operation of the laser diode device, can be further suppressed.

In the aforementioned laser diode device according to the second aspect, the support base preferably has a groove between a portion arranged with the first heat radiation substrate and a portion arranged with the second heat radiation substrate. According to this structure, it is possible to further reduce transmission of heat from the green and blue laser diode elements to the red laser diode element by the groove of the support base.

In the aforementioned laser diode device according to the second aspect, the support base has a first support base arranged with the first heat radiation substrate and a second support base, separated from the first support base, arranged with the second heat radiation substrate. According to this structure, because the first heat radiation substrates is separated from the second heat radiation substrate, and because the first support base arranged with the first heat radiation substrate is also separated from the second support base arranged with the second heat radiation substrate, it is possible to further reduce transmission of heat from the green and blue laser diode elements to the red laser diode element.

A display apparatus according to a third aspect of the present invention comprises a laser diode device including a red laser diode element, a green laser diode element and a blue laser diode element, wherein the red, green and blue laser diode elements are arranged in a package, and the blue laser diode element is arranged between the red laser diode element and the green laser diode element as viewed from a laser beam-emitting direction, and means for modulating light from the laser diode device.

In the display apparatus according to the third aspect of the present invention, as hereinabove described, the blue laser diode element is arranged between the red and green laser diode elements, whereby it is possible to reduce transmission of heat from the green laser diode element where the large amount of heat is generated to the red laser diode element and hence desirable images can be displayed by modulating light with the modulation means employing the laser diode device in which deterioration of lasing characteristics resulting from rising temperature of the red laser diode element during operation of the laser diode device, can be suppressed.

In the aforementioned display apparatus according to the third aspect, the red, green and blue laser diode elements preferably substantially simultaneously lase or alternately lase in time series. As to the “substantially simultaneously lase”, start of the lasing of the red, green and blue laser diode elements not always have to coincide with each other, so far as one of the laser diode elements lases during the other laser diode element lases. Thus, when the red, green and blue laser diode elements substantially simultaneously lase or alternately lase in time series, the number of lased laser elements or a total lasing time is increased as compared with a case of individual lasing and hence the total amount of generated heat by operating the red, green and blue laser diode elements is increased. In this case, the red and green laser diode elements are arranged so as not to be adjacent to each other, whereby it is possible to reduce transmission of heat from the green laser diode element where the large amount heat is generated to the red laser diode element, and hence the display apparatus, in which deterioration of lasing characteristics resulting from rising temperature of the red laser diode element during operation can be effectively suppressed, can be obtained.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram of a structure of a laser diode device according to a first embodiment of the present invention as viewed from a direction perpendicular to a light-emitting direction;

FIG. 2 is a sectional view showing the structure of the laser diode device taken along the line 1000-1000 in FIG. 1;

FIG. 3 is a schematic diagram showing a projector comprising the laser diode device according to the first embodiment shown in FIG. 1, in which laser diode elements are alternately lighted in time series;

FIG. 4 is a timing chart showing a state in which a control unit according to the first embodiment shown in FIG. 3 transmits signals in time series;

FIG. 5 is a schematic diagram showing a projector comprising the laser diode device according to the first embodiment shown in FIG. 1, in which laser diode elements are substantially simultaneously lighted;

FIG. 6 is a diagram of a structure of a laser diode device according to a modification of the first embodiment of the present invention as viewed from a direction perpendicular to a light-emitting direction;

FIG. 7 is a sectional view showing the structure of the laser diode device taken along the line 2000-2000 in FIG. 6;

FIG. 8 is a diagram of a structure of a laser diode device according to a second embodiment of the present invention as viewed from a direction perpendicular to a light-emitting direction;

FIG. 9 is a sectional view showing the structure of the laser diode device taken along the line 3000-3000 in FIG. 8;

FIG. 10 is a diagram of a structure of a laser diode device according to a third embodiment of the present invention as viewed from a direction perpendicular to a light-emitting direction;

FIG. 11 is a sectional view showing the structure of the laser diode device taken along the line 4000-4000 in FIG. 10;

FIG. 12 is a diagram of a structure of a laser diode device according to a fourth embodiment of the present invention as viewed from a direction perpendicular to a light-emitting direction;

FIG. 13 is a sectional view showing the structure of the laser diode device taken along the line 5000-5000 in FIG. 12;

FIG. 14 is a sectional view showing a structure of a laser diode device according to a modification of the present invention;

FIGS. 15 and 16 are sectional views showing a structure of a laser diode device according to a modification of the present invention; and

FIG. 17 is a diagram of a structure of a laser diode device according to a modification of the present invention as viewed from a direction perpendicular to the light-emitting direction.

### DESCRIPTION OF THE PREFERRED EMBODIMENTS

Embodiments of the present invention will be hereinafter described with reference to the drawings.

### First Embodiment

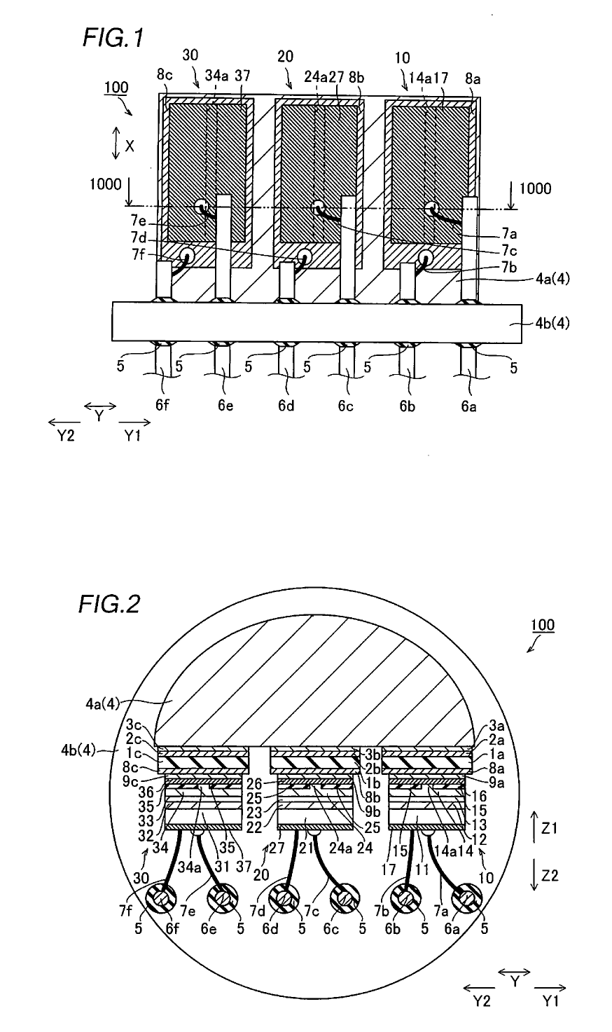

A structure of a laser diode device 100 according to a first embodiment of the present invention will be now described with reference to FIGS. 1 and 2.

In the laser diode device 100 according to the first embodiment of the present invention, a red laser diode element 10 having an lasing wavelength of about 640 nm and a blue laser diode element 20 having an lasing wavelength of about 465 nm and a green laser diode element 30 having an lasing wavelength of about 530 nm are bonded to surfaces of heat radiation substrates 1a, 1b and 1c (see FIG. 2) arranged with prescribed intervals successively from a first end side (Y1 side) which is a direction perpendicular to a laser beam-emitting direction, as viewed from the laser beam-emitting direction (direction X), as shown in FIGS. 1 and 2. Thus, the laser diode device 100 constitutes a RGB three-wavelength laser diode device. The red laser diode element 10 is arranged in the vicinity of the end of a package 4 (support base 4a), described later, on the Y1 side, and the green laser diode element 30 is arranged in the vicinity of an end of the package 4 (support base 4a) on a second end side (Y2 side) which is the direction perpendicular to the laser beam-emitting direction. The red laser diode element 10 may be formed to have lasing wavelengths in the range of about 610 nm to about 750 nm. The blue laser diode element 20 may be formed to have lasing wavelengths in the range of about 435 nm to about 485 nm. The green laser diode element 30 may be formed to have lasing wavelengths in the range of about 500 nm to about 565 nm. The heat radiation substrate 1a is an example of the “first heat radiation substrate” in the present invention. The heat radiation substrate 1b is an example of the “second heat radiation substrate” or the “fourth heat radiation substrate” in the present invention, and the heat radiation substrate 1c is an example of the “second heat radiation substrate” or the “third heat radiation substrate” in the present invention.

The laser diode device 100 is formed to be usable as a light source for display. In other words, the laser diode device 100 is so formed that the red, blue and green laser diode elements 10, 20 and 30 substantially simultaneously lase or alternately lase in time series. Thus, the laser diode device 100 is formed to be usable as a light source for display capable of displaying a plurality of colors including white.

According to the first embodiment, as shown in FIG. 2, the heat radiation substrates 1a, 1b and 1c are provided in order to radiate heat generated in the red, blue and green laser diode elements 10, 20 and 30 to the support base 4a described later, respectively. The heat radiation substrates 1a, 1b and 1c are made of AlN having insulating properties and high thermal conductivity. Diamond, SiC or the like having insulating properties and having high thermal conductivity may be used for the heat radiation substrates 1a, 1b and 1c. The heat radiation substrate 1a may be made of Cu, and the heat radiation substrates 1b and 1c may be made of Si. According to this structure, the heat radiation substrate 1a (Cu) has higher thermal conductivity than the heat radiation substrates 1b and 1c (Si), and hence heat can be efficiently radiated from the red laser diode element 10 to the support base 4a through the heat radiation substrate 1a. The heat radiation substrates 1b and 1c have lower thermal conductivity than the heat radiation substrate 1a, and hence it is possible to retard heat transfer from the green and blue laser diode elements 30 and 20 to the support base 4a through the heat radiation substrates 1b and 1c to some extent. Therefore, it is possible that heat is hard to transmit to the red laser diode element 10.

The heat radiation substrates 1a, 1b and 1c are bonded to a flat surface of the conductive support base 4a through metal layers 2a, 2b and 2c containing Au and conductive fusion layers 3a, 3b and 3c made of solder containing AuSn. The metal layers 2a, 2b and 2c are formed in order to improve wettability of the fusion layers 3a, 3b and 3c to the heat radiation substrate 1a, 1b and 1c, respectively. The support base 4a is made of Cu or Fe having high thermal conductivity, and has a surface provided with Au plating. Thus, the support base 4a is enabled to radiate heat. The support base 4a is integrally bonded with a conductive stem body 4b. The conductive support base 4a and stem body 4b are components of the package 4. The package 4 is grounded.

According to the first embodiment, the heat radiation substrate 1a concerned with the red laser diode element 10 is bonded on the Y1 side of the support base 4a, and the heat radiation substrate 1c concerned with the green laser diode element 30 is bonded on the Y2 side of the support base 4a. The heat radiation substrate 1b concerned with the blue laser diode element 20 is bonded to the support base 4a so as to be arranged between the heat radiation substrates 1a and 1c. Thus, the red and green laser diode elements 10 and 30 are arranged to hold the blue laser diode element 20 therebetween on a surface of the support base 4a so as not to be adjacent to each other. The red, blue and green laser diode elements 10, 20 and 30 are arranged in the single package 4, and the heat radiation substrates 1a, 1b and 1c are arranged between the red, blue and green laser diode elements 10, 20 and 30 and the support base 4a, respectively.

As shown in FIGS. 1 and 2, the stem body 4b is mounted with lead terminals 6a, 6b, 6c, 6d, 6e and 6f successively from the Y1 side through insulating rings 5. The lead terminals 6a, 6b, 6c, 6d, 6e and 6f are connected to a power supply (not shown). First ends of conductive wires 7a, 7b, 7c, 7d, 7e and 7f made of Au are connected to the lead terminals 6a, 6b, 6c, 6d, 6e and 6f, respectively. The wires 7a, 7b, 7c, 7d, 7e and 7f are provided in order to supply power to the laser diode elements (red, blue and green laser diode elements 10, 20 and 30).

As shown in FIG. 2, the metal layers 8a, 8b and 8c containing Au are formed on the surfaces of the heat radiation substrates 1a, 1b and 1c, respectively. As shown in FIG. 1, second ends of the wires 7b, 7d and 7f are connected to the metal layers 8a, 8b and 8c, respectively.

According to the first embodiment, fusion layers 9a, 9b and 9c made of conductive solder containing AuSn and having high thermal conductivity are formed on the surfaces of the metal layers 8a, 8b and 8c, respectively, as shown in FIG. 2. The fusion layers 9a, 9b and 9c are provided in order to bond the red, blue and green laser diode elements 10, 20 and 30 to the heat radiation substrates 1a, 1b and 1c, respectively, and radiate heat generated in the red, blue and green laser diode elements 10, 20 and 30 to the heat radiation substrates 1a, 1b and 1c, respectively.

According to the first embodiment, the red laser diode element 10 has a structure in which an n-type cladding layer 12 made of n-type AlGaInP, an active layer 13 made of AlInGaP and a p-type cladding layer 14 made of p-type AlGaInP are stacked in this order on a surface of an n-type GaAs substrate 11. The blue laser diode element 20 has a structure in which an n-type cladding layer 22 made of n-type AlInGaN, an active layer 23 made of InGaN and a p-type cladding layer 24 made of p-type AlInGaN are stacked in this order on a surface of an n-type GaN substrate 21. The green laser diode element 30 has a structure in which an n-type cladding layer 32 made of n-type AlInGaP, an active layer 33 made of InGaN and a p-type cladding layer 34 made of p-type AlInGaN are stacked in this order on a surface of an n-type InGaN substrate 31. The active layers 13, 23 and 33 may be formed by single-layer structures, single quantum well (SQW) structures formed by alternately stacking two barrier layers (not shown) and a well layer (not shown), or multiple quantum well (MQW) structures formed by alternately stacking a plurality of barrier layers (not shown) and a plurality of well layers (not shown). The n-type GaAs substrate 11 is an example of the “GaAs substrate” in the present invention, and InGaN and AlInGaN are examples of the “nitride-based semiconductor” in the present invention.

The p-type cladding layers 14, 24 and 34 have ridge portions 14a, 24a and 34a formed on substantially central portions of the elements and planar portions extending in a direction (direction Y) perpendicular to the laser beam-emitting directions of the ridge portions 14a, 24a and 34a. As shown in FIG. 1, the ridge portions 14a, 24a and 34a are formed to extend along a cavity direction (direction X).

In other words, the red, blue and green laser diode elements 10, 20 and 30 are formed to have structures of ridge waveguide laser elements. As shown in FIG. 2, p-type contact layers for improving contact characteristics with p-side electrodes 16, 26 and 36 described later may be provided on upper portions of the p-type cladding layers 14, 24 and 34 constituting the ridge portions 14a, 24a and 34a, respectively.

According to the first embodiment, the “first light-emitting portion”, the “third light-emitting portion” and the “second light-emitting portion” of the present invention in the red, blue and green laser diode elements 10, 20 and 30 are formed on portions of the active layers 13, 23 and 33 located on lower portions (base portions) of the ridge portions 14a, 24a and 34a, respectively. The red, blue and green laser diode elements 10, 20 and 30 are so bonded to the heat radiation substrates 1a, 1b and 1c, respectively, that the ridge portions 14a, 24a and 34a are located on the support base 4a side (Z1 side) of the package 4. Therefore, the red, blue and green laser diode elements 10, 20 and 30 are bonded to the heat radiation substrates 1a, 1b and 1c in a junction-down system, respectively.

Current blocking layers 15, 25 and 35 made of SiO₂ are so formed as to cover planar portions of the p-type cladding layers 14, 24 and 34 and side surfaces of the ridge portions 14a, 24a and 34a. The p-side electrodes 16, 26 and 36 made of Au are formed on surfaces of the ridge portions 14a, 24a and 34a and the current blocking layers 15, 25 and 35, respectively. The p-side electrodes 16, 26 and 36 are connected to the wires 7b, 7d and 7f through the metal layers 8a, 8b and 8c and the fusion layers 9a, 9b and 9c, respectively.

An n-side electrode 17 containing Au is formed on the surface of the n-type GaAs substrate 11. An n-side electrode 27 containing Au is formed on the surface of the n-type GaN substrate 21. An n-side electrode 37 containing Au is formed on the surface of the n-type InGaN substrate 31. As shown in FIGS. 1 and 2, second ends of the wires 7a, 7c and 7e are connected to the n-side electrodes 17, 27 and 37, respectively. In other words, the single wires 7a, 7c and 7e are connected to the n-side electrodes 17, 27 and 37, respectively, which are electrodes on an opposite side to the package 4 (support base 4a) side.

The red laser diode element 10 is formed to be operable by applying a voltage between the lead terminals 6a and 6b (lead terminal 6b is a positive potential). The blue laser diode element 20 is formed to be operable by applying a voltage between the lead terminals 6c and 6d (lead terminal 6d is a positive potential). The green laser diode element 30 is formed to be operable by applying a voltage between the lead terminals 6e and 6f (lead terminal 6f is a positive potential).

Projectors 140 and 150 each comprising the laser diode device 100 according to the first embodiment of the present invention will be now described with reference to FIGS. 2 to 5.

Referring to FIGS. 2 to 4, the projector 140 in which the laser diode elements are alternately lighted in time series will be described.

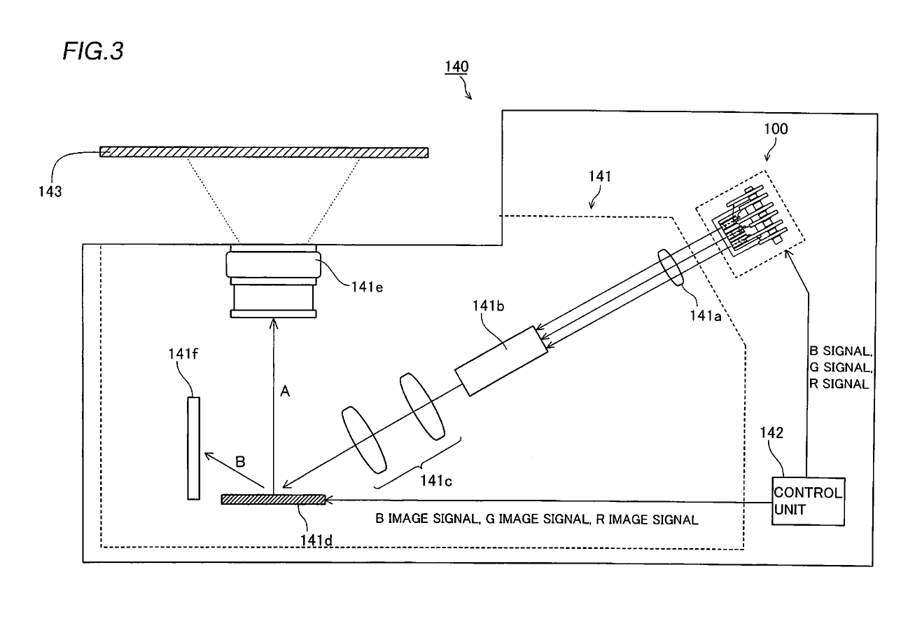

The projector 140 according to the first embodiment of the present invention is provided with the laser diode device 100 including the red, blue and green laser diode elements 10, 20 and 30 (see FIG. 2), an optical system 141 including a plurality of optical components and a control unit 142 controlling the laser diode device 100 and the optical system 141, as shown in FIG. 3. Thus, light from the laser diode device 100 is modulated by the optical system 141 and thereafter projected on a screen 143 or the like. The optical system 141 is an example of the “means for modulating light” in the present invention.

Light emitted from the laser diode device 100 is converted to parallel light by a lens 141a and thereafter incident on a light pipe 141b in the optical system 141.

An inner surface of the light pipe 141b is a mirror surface, and light proceeds in the light pipe 141b while repeating reflection on the inner surface of the light pipe 141b. At this time, light intensity distribution of each color emitted from the light pipe 141b is uniformized by multiple refection in the light pipe 141b. The light emitted from the light pipe 141b is incident on a digital micro-mirror device (DMD) 141d through a relay optical system 141c.

The DMD device 141d is constituted by a small mirror group arranged in the form of a matrix. The DMD device 141d has a function of representing (modulating) gradation of each pixel by switching a reflection direction of light on each pixel position, between a first direction A for going toward the projection lens 141e or a second direction B for departing from the projection lens 141e. Light reflected in the first direction A by the DMD device 141d is projected on a screen 143 through the projection lens 141e. A light absorber 141f absorbs light reflected in the second direction B by the DMD device 141d without being incident on the projection lens 141e.

In the projector 140, the control unit 142 controls to supply a pulse voltage to the laser diode device 100, so that the red, blue and green laser diode elements 10, 20 and 30 of the laser diode device 100 are divided in time series to be alternately (cyclically) operated per element. The DMD device 141d of the optical system 141 is so formed as to modulate gradation of each pixel while synchronizing with operation of the red, blue and green laser diode elements 10, 20 and 30 by the control unit 142.

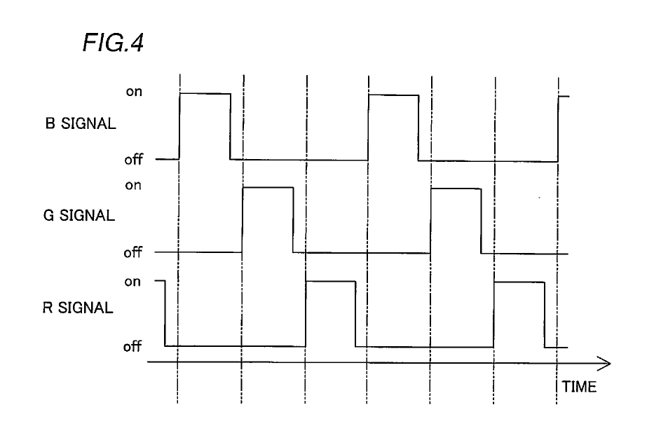

More specifically, a signal B regarding operation of the blue laser diode element 20, a signal G regarding operation of the green laser diode element 30 and a signal R regarding operation of the red laser diode element 10 are divided in time series so as not to overlap with each other as shown in FIG. 4, and are supplied to the respective laser elements of the laser diode device 100 by the control unit 142. Image signals B, G and R are outputted from the control unit 142 to the DMD device 141d in synchronization with the signals B, G and R, respectively.

Thus, blue light of the blue laser diode element 20 is emitted according to the signal B, and the DMD device 141d modulates the blue light according to the image signal B at this timing. Green light of the green laser diode element 30 is emitted according to the signal G outputted next to the signal B, and the DMD device 141d modulates the green light according to the image signal G at this timing. Red light of the red laser diode element 10 is emitted according to the signal R outputted next to the signal G, and the DMD device 141d modulates the red light according to the image signal R at this timing. Thereafter, blue light of the blue laser diode element 20 is emitted according to the signal B outputted next to the signal R, and the DMD device 141d modulates the blue light according to the image signal Bat this timing again. The aforementioned operation is repeated, so that an image by laser beam irradiation according to the image signals B, G and R is projected on the screen 143. Thus, the projector 140, in which the laser diode device 100 according to the first embodiment of the present invention is alternately lighted in time series, is formed.

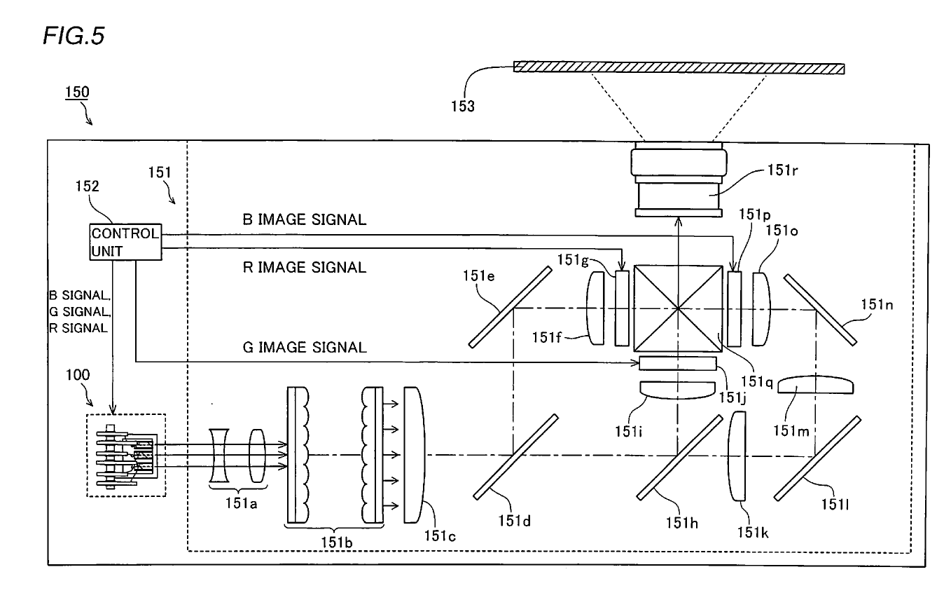

The projector 150 in which the laser diode elements are substantially simultaneously lighted will be now described with reference to FIGS. 2 and 5.

The projector 150 according to the first embodiment of the present invention is provided with the laser diode device 100 including the red, blue and green laser diode elements 10, 20 and 30 (see FIG. 2), an optical system 151 including a plurality of optical components and a control unit 152 controlling the laser diode device 100 and the optical system 151, as shown in FIG. 5. Thus, a laser beam emitted from the laser diode device 100 is modulated by the optical system 151 and thereafter projected on an external screen 153 or the like. The optical system 151 is an example of the “means for modulating light” in the present invention.

In the optical system 151, the laser beam emitted from the laser diode device 100 is converted to parallel light having a prescribed beam radius by a dispersion angle control lens 151a each consisting of a concave lens and a convex lens and thereafter incident on a fly's eye integrator 151b. In the fly's eye integrator 151b, two fly's eye lenses each consisting of a plurality lenses arranged in the form of a fly's eye are opposed to each other, and the fly's eye integrator 151b has a function of uniformizing light intensity distribution of light from the dispersion angle control lens 151a. In other words, light transmitted through the fly's eye integrator 151b is adjusted to have an aspect ratio (16:9, for example) corresponding to that of the liquid crystal panels 151g, 151j and 151p.

The light transmitted through the fly's eye integrator 151b is condensed by a condenser lens 151c. Among red, green and blue lights transmitted through the condenser lens 151c, only red light is reflected by a dichroic mirror 151d, while green light and blue light are transmitted through the dichroic mirror 151d.

Red light reflected on a mirror 151e and thereafter parallelized by a lens 151f is incident on the liquid crystal panel 151g through a polarization plate (not shown). The liquid crystal panel 151g is operated with an operation signal (image signal R) to modulate red light.

Only green light among green and blue lights transmitted through the dichroic mirror 151d is reflected by a dichroic mirror 151h, while blue light is transmitted through the dichroic mirror 151h.

Green light parallelized by a lens 151i is incident on the liquid crystal panel 151j through a polarization plate on (not shown). The liquid crystal panel 151j is operated with an operation signal (image signal G) to modulate green light.

Blue light transmitted through the dichroic mirror 151h is reflected on a lens 151k, a mirror 151l, a lens 151m and a mirror 151n and parallelized by a lens 151o, and thereafter incident on the liquid crystal panel 151p through a polarization plate (not shown). The liquid crystal panel 151p is operated with an operation signal (image signal B) to modulate blue light.

Thereafter, the red light, the green light and the blue light modulated by the liquid crystal panels 151g, 151j and 151p, respectively, are composited by a dichroic prism 151q, and thereafter incident on a projection lens 151r through a polarization plate (not shown). The projection lens 151r is consist of a lens group for forming an image on a screen 153 with projected light, and an actuator for adjusting zoom and focus of an projected image by displacing a part of the lens group in an optical axis direction.

In the projector 150, the control unit 152 so controls that stationary voltages as a signal B regarding operation of the blue laser diode element 20, a signal G regarding operation of the green laser diode element 30 and a signal R regarding operation of the red laser diode element 10 are supplied to the respective laser elements of the laser diode device 100. Thus, the red, blue and green laser diode elements 10, 20 and of the laser diode device 100 are substantially simultaneously lased. The control unit 152 controls intensity of each light of the red, blue and green laser diode elements 10, 20 and 30 of the laser diode device 100, so that color phase, brightness or the like of pixels projected on the screen 153 is controlled. Thus, a desirable image is projected on the screen 153 based on signals from the control unit 152. Thus, the projector 150, in which the laser diode device 100 according to the first embodiment of the present invention is substantially simultaneously lighted, is formed.

According to the first embodiment, as hereinabove described, the blue laser diode element 20 is arranged between the red and green laser diode elements 10 and 30 on the surface of the support base 4a, whereby it is possible to reduce transmission of heat from the green laser diode element 30 where the large amount of heat is generated to the red laser diode element 10 can be reduced and hence deterioration of lasing characteristics resulting from rising temperature of the red laser diode element 10 during operation of the laser diode device 100. Heat generated in the red, blue and green laser diode elements 10, 20 and 30 can be radiated outside by the support base 4a.

According to the first embodiment, the single wires 7a, 7c and 7e are connected to the n-side electrodes 17, 27 and 37, respectively, which are the electrodes on the opposite side to the package 4 (support base 4a) side, whereby the flexibility of wiring for supplying power can be improved and heat generated by the respective laser diode elements can be radiated from the portions of wires (7a, 7c and 7e) independently connected to the respective laser diode elements (red, blue and green laser diode elements 10, 20 and 30), and hence deterioration of lasing characteristics resulting from rising temperature of the red laser diode element 10 during operation of the laser diode device 100 can be suppressed.

According to the first embodiment, the red laser diode element 10 is formed on the n-type GaAs substrate 11 and each of the green and blue laser diode elements 30 and 20 is made of materials containing AlInGaN, whereby the red laser diode element 10 and the green and blue laser diode elements 30 and 20 in the laser diode device 100 can be easily formed.

According to the first embodiment, the heat radiation substrate 1a is separated from the heat radiation substrates 1b and 1c, whereby transmission of heat from the green and blue laser diode elements 30 and 20 to the red laser diode element 10 through the heat radiation substrates 1a, 1b and 1c can be reduced. The heat generated in the red laser diode element 10 can be radiated through the heat radiation substrate 1a, and heat generated in the green and blue laser diode elements 30 and 20 can be radiated through the heat radiation substrate 1c and 1b, respectively. Thus, deterioration of lasing characteristics resulting from rising temperature of the red laser diode element 10 during operation of the laser diode device 100 can be suppressed. The heat generated in the green laser diode element 30 and the heat generated in the blue laser diode element 20 can be separately radiated through the heat radiation substrates 1c and 1b, and hence it is possible that heat is hard to transmit to the red laser diode element 10.

According to the first embodiment, the ridge portion 14a of the red laser diode element 10 is formed on the support base 4a side, whereby heat generated around a light-emitting portion of the red laser diode element 10 (portion of the active layer 13 on the lower portion (base portions) of the ridge portion 14a) can be easily radiated through the support base 4a provided in the vicinity of the light-emitting portion of the red laser diode element 10, and hence deterioration of lasing characteristics resulting from rising temperature of the red laser diode element 10 during operation of the laser diode device 100 can be suppressed.

According to the first embodiment, when the red, green and blue laser diode elements 10, 30 and 20 are substantially simultaneously lased, or alternately lased in time series, the amount of heat generated by operating the red, green and blue laser diode elements 10, 30 and 20 is increased, even in this case, the red and green laser diode elements 10 and 30 are arranged so as not to be adjacent to each other, whereby transmission of heat from the green laser diode element 30 where the large amount of heat is generated to the red laser diode element 10 can be reduced, and hence deterioration of lasing characteristics resulting from rising temperature of the red laser diode element 10 during operation of the laser diode device 100 can be effectively suppressed.

According to the first embodiment, the red, blue and green laser diode elements 10, 20 and 30 are bonded to the heat radiation substrates 1a, 1b and 1c, respectively, in a junction-down system, whereby heat generated around the first light-emitting portion of the red laser diode element 10 can be easily radiated from the support base 4a and the heat radiation substrate 1a located in the vicinity of the first light-emitting portion. Additionally, heat generated around the second light-emitting portion of the green laser diode element 30 and heat generated around the third light-emitting portion of the blue laser diode element 20 can be easily radiated to the support base 4a through the heat radiation substrates 1c and 1b located in the vicinity of the third and second light-emitting portions.

According to the first embodiment, the red laser diode element 10 is arranged in the vicinity of the end of the support base 4a on the Y1 side, and the green laser diode element 30 is arranged in the vicinity of the end of the support base 4a on the Y2 side, whereby intervals between the red and green laser diode elements 10 and 30 can be increased and hence transmission of heat from the green laser diode element 30 where the large amount of heat is generated to the red laser diode element 10 can be further reduced and deterioration of lasing characteristics resulting from rising temperature of the red laser diode element 10 can be suppressed.

According to the first embodiment, in the projector 140, the control unit 142 controls to supply the pulse voltage to the laser diode device 100, so that the red, blue and green laser diode elements 10, 20 and 30 of the laser diode device 100 are divided in time series to be alternately operated per element. In this case, the amount of heat generated by operating the red, blue and green laser diode elements 10, 20 and 30 is increased due to alternate operation as compared with a case where only the red laser diode element 10 is operated. However, also in this case, transmission of heat from the green laser diode element 30 where the large amount of heat is generated to the red laser diode element 10 can be reduced by arranging the red and green laser diode elements 10 and 30 so as not to be adjacent to each other, and hence deterioration of lasing characteristics resulting from rising temperature of the red laser diode element 10 during operation of the laser diode device 100 can be effectively suppressed.

According to the first embodiment, in the projector 150, the control unit 152 so controls that a stationary voltage is supplied to the laser diode device 100, whereby the red, blue and green laser diode elements 10, 20 and 30 of the laser diode device 100 are substantially simultaneously lased. In this case, the amount of heat generated by operating the red, blue and green laser diode elements 10, 20 and 30 is increased due to substantially simultaneous lasing of the respective laser diode elements as compared with a case where only the red laser diode element 10 is operated. However, also in this case, transmission of heat from the green laser diode element 30 where the large amount of heat is generated to the red laser diode element 10 can be reduced by arranging the red and green laser diode elements 10 and 30 so as not to be adjacent to each other, and hence deterioration of lasing characteristics resulting from rising temperature of the red laser diode element 10 during operation of the laser diode device 100 can be effectively suppressed.

According to the first embodiment, the laser diode device 100 and the optical system 141 are provided in the projector 140, and the laser diode device 100 and the optical system 151 are provided in the projector 150, whereby desirable images can be displayed by modulating light with the optical systems 141 and 151 employing the laser diode device 100 in which deterioration of the red laser diode element 10 having a long lasing wavelength can be suppressed.

### Modification of First Embodiment

A modification of the first embodiment will be now described with reference to FIGS. 1, 6 and 7. In a laser diode device 200 according to the modification of the first embodiment, anode common connection in which positive electrodes (p-sides) are common is achieved by electrically connecting p-side electrodes 16, 26 and 36 to a support base 4a through conductive heat radiation substrates 201a, 201b and 201c, respectively, dissimilarly to the aforementioned first embodiment.

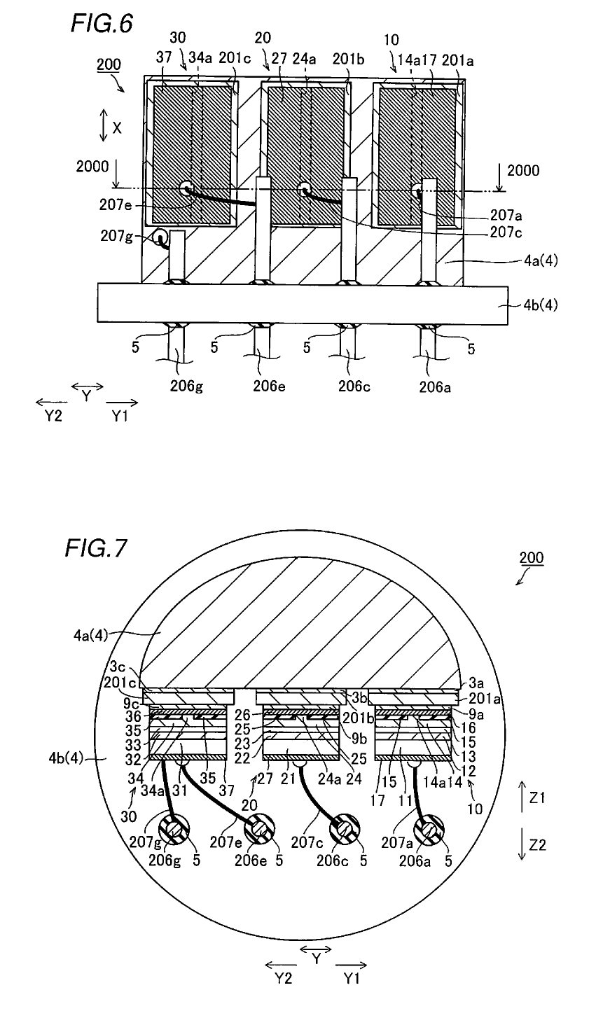

In the laser diode device 200 according to the modification of the first embodiment of the present invention, lead terminals 206a, 206c, 206e and 206g are mounted successively from a Y1 side on a conductive stem body 4b of a grounded package 4, as shown in FIGS. 6 and 7. First ends of wires 207a, 207c, 207e and 207g are connected to lead terminals 206a, 206c, 206e and 206g, respectively. As shown in FIG. 6, a second end of the wire 207g is connected to a surface of the conductive support base 4a.

According to the modification of the first embodiment, red, blue and green laser diode elements 10, 20 and 30 are bonded to the heat radiation substrates 201a, 201b and 201c arranged successively from the Y1 side with prescribed intervals by fusion layers 9a, 9b and 9c, respectively, as shown in FIG. 7. The heat radiation substrates 201a, 201b and 201c are made of Cu having conductivity and having high thermal conductivity. The heat radiation substrates 201a, 201b and 201c may be made of conductive Al and having high thermal conductivity. The heat radiation substrate 201a is an example of the “first heat radiation substrate” in the present invention, and the heat radiation substrates 201b and 201c are examples of the “second heat radiation substrate” in the present invention.

According to the modification of the first embodiment, the heat radiation substrates 201a, 201b and 201c are bonded to the conductive support base 4a through conductive fusion layers 3a, 3b and 3c made of solder containing AuSn, respectively. Thus, the p-side electrodes 16, 26 and 36 of the red, blue and green laser diode elements 10, 20 and 30 are electrically connected to the support base 4a through the fusion layers 9a, 9b and 9c, the heat radiation substrates 201a, 201b and 201c and the fusion layers 3a, 3b and 3c, respectively. In other words, all of the p-side electrodes 16, 26 and 36 of the red, blue and green laser diode elements 10, 20 and 30 are electrically connected. Namely, the anode common connection in which the positive electrodes (p-side electrodes) are common is achieved. Thus, the three lead terminals 6b, 6d and 6f (see FIG. 1) in the aforementioned first embodiment are replaced to one lead terminal 206g, and the three wires 7b, 7d and 7f (see FIG. 1) in the aforementioned first embodiment are replaced to one wire 207g. Consequently, the number of lead terminals and the number of wires can be reduced, and hence wire distribution can be simplified and the laser diode device 200 can be downsized.

As shown in FIGS. 6 and 7, second ends of the wires 207a, 207c and 207e are connected to the n-side electrodes 17, 27 and 37, respectively. Thus, the red laser diode element 10 is so formed as to be operable by applying a voltage between the lead terminals 206a and 206g. The blue laser diode element 20 is so formed as to be operable by applying a voltage between the lead terminals 206c and 206g. The green laser diode element 30 is so formed as to be operable by applying a voltage between the lead terminals 206e and 206g. The remaining structure of the modification of the first embodiment is similar to that of the aforementioned first embodiment.

According to the modification of the first embodiment, as hereinabove described, the package 4 (support base 4a) and the heat radiation substrates 201a, 201b and 201c are formed to be conductive, whereby no wire is required for connecting the package 4 and the p-side electrodes 16, 36 and 26 of the red, green and blue laser diode elements 10, 30 and 20, and hence wire distribution in the laser diode device 200 can be inhibited from complication. The effects of the modification of the first embodiment are similar to those of the aforementioned first embodiment.

### Second Embodiment

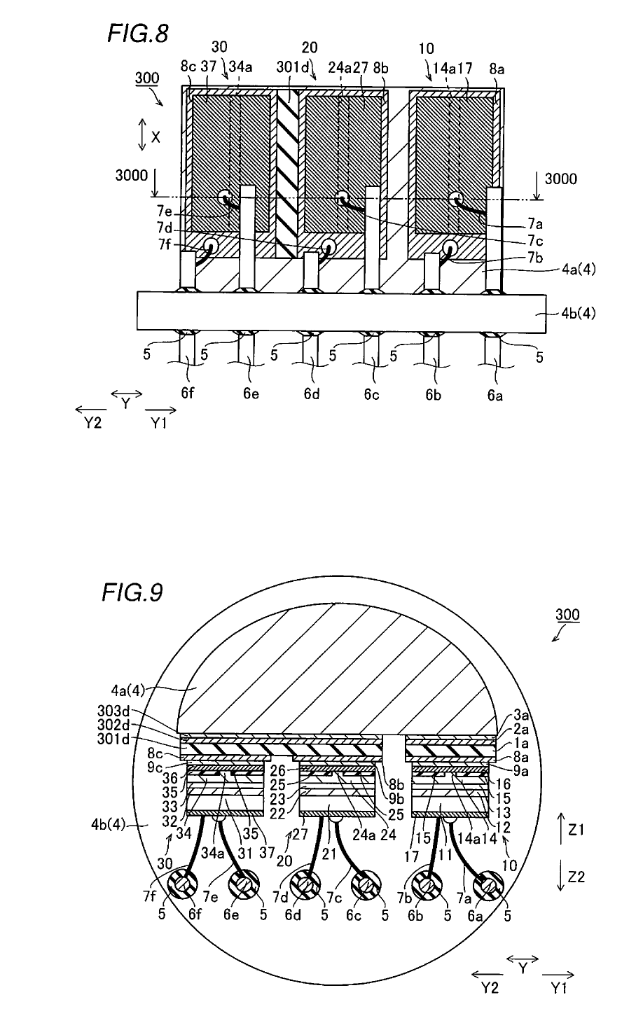

A second embodiment will be now described with reference to FIGS. 8 and 9. In a laser diode device 300 according to the second embodiment, blue and green laser diode elements 20 and 30 are bonded on a surface of the same heat radiation substrate 301d with a prescribed interval, dissimilarly to the aforementioned first embodiment. The heat radiation substrate 301d is an example of the “second heat radiation substrate” in the present invention.

In the laser diode device 300 according to the second embodiment of the present invention, the blue and green laser diode elements 20 and 30 are bonded on the surface of the heat radiation substrate 301d with the prescribed interval, as shown in FIGS. 8 and 9. More specifically, the heat radiation substrate 301d made of AlN having insulating properties and having high thermal conductivity is arranged to extend from a Y2 side of a support base 4a to the vicinity of a central portion in a direction Y, as shown in FIG. 9. The heat radiation substrate 301d is bonded to the Y2 side of the conductive support base 4a through a metal layer 302d containing Au by a conductive fusion layer 303d made of solder containing AuSn.

A p-side electrode 26 side of the blue laser diode element 20 is bonded on a metal layer 8b on a Y1 side of the heat radiation substrate 301d by a fusion layer 9b in a junction-down system. A p-side electrode 36 side of the green laser diode element 30 is bonded on a metal layer 8c on the Y2 side of the heat radiation substrate 301d by a fusion layer 9c in a junction-down system. Similarly to the first embodiment, the red laser diode element 10 is bonded to a heat radiation substrate 1a bonded to the Y1 side of the support base 4a through a metal layer 8a by a fusion layer 9a. Thus, the red and green laser diode elements 10 and 30 are arranged to hold the blue laser diode element 20 therebetween so as not to be adjacent to each other. The remaining structure of the second embodiment is similar to that of the aforementioned first embodiment.

According to the second embodiment, as hereinabove described, the blue and green laser diode elements 20 and 30 are bonded on the surface of the same heat radiation substrate 301d with an interval, whereby the number of components can be reduced in assembling the laser diode device 300, and hence the laser diode device 300 can be easily assembled. The effects of the second embodiment are similar to those of the aforementioned first embodiment.

### Third Embodiment

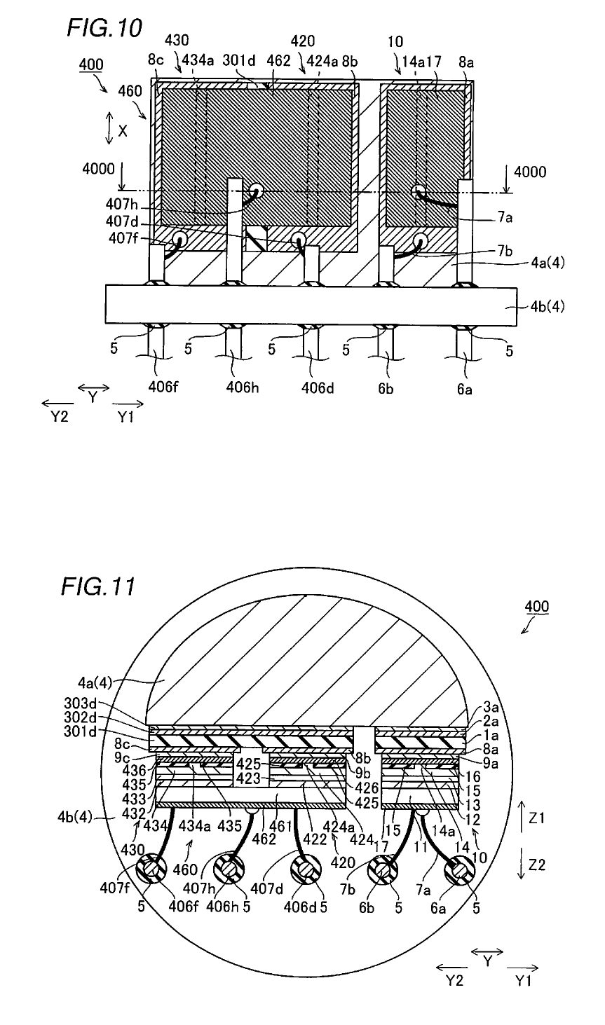

A third embodiment will be now described with reference to FIGS. 10 and 11. In a laser diode device 400 according to a third embodiment, a monolithic blue and green two-wavelength laser diode element portion 460 is formed by blue and green laser diode elements 420 and 430, dissimilarly to the aforementioned second embodiment.

In the laser diode device 400 according to the third embodiment of the present invention, lead terminals 6a, 6b, 406d, 406h and 406f are mounted successively from a Y1 side on a stem body 4b of a package 4, as shown in FIG. 10. First ends of wires 7a, 7b, 407d, 407h and 407f are connected to the lead terminals 6a, 6b, 406d, 406h and 406f, respectively.

According to the third embodiment, the monolithic blue and green two-wavelength laser diode element portion 460 forms the blue and green laser diode elements 420 and 430, as shown in FIG. 11. More specifically, the blue laser diode element 420 has a structure in which an n-type cladding layer 422 made of n-type AlInGaN, an active layer 423 made of InGaN and a p-type cladding layer 424 made of p-type AlInGaN and having a ridge portion 424a are stacked in this order on a surface on a Y1 side of an n-type GaN substrate 461. The green laser diode element 430 has a structure in which an n-type cladding layer 432 made of n-type AlInGaN and an active layer 433 made of InGaN and a p-type cladding layer 434 made of p-type AlInGaN and having a ridge portion 434a are stacked in this order on a surface on a Y2 side of the n-type GaN substrate 461 identical with the substrate formed with the blue laser diode element 420. The “second light-emitting portion” and the “third light-emitting portion” of the present invention in the blue and green laser diode elements 420 and 430 are formed on portions of the active layers 423 and 433 located on lower portions of the ridge portions 424a and 434a, respectively.

Current blocking layers 425 and 435 made of SiO₂ are so formed as to cover planar portions of the p-type cladding layers 424 and 434 and side surfaces of the ridge portions 424a and 434a. P-side electrodes 426 and 436 made of Au are formed on surfaces of the ridge portions 424a and 434a and the current blocking layers 425 and 435, respectively. P-type contact layers for improving contact characteristics with the p-side electrodes 426 and 436 may be provided on upper portions of the p-type cladding layers 424 and 434 constituting the ridge portions 424a and 434a, respectively. An n-side electrode 462 containing Au is formed on a surface of the n-type GaN substrate 461. Thus, the n-side electrode 462 of the blue and green laser diode elements 420 and 430 is electrically connected. Namely, cathode common connection in which negative electrodes (n-side electrodes) are common is achieved.

The p-side electrode 426 of the blue laser diode element 420 is bonded on a metal layer 8b on a Y1 side of the heat radiation substrate 301d by a fusion layer 9b in a junction-down system. The p-side electrode 436 of the green laser diode element 430 is bonded on a metal layer 8c on a Y2 side of the heat radiation substrate 301d by a fusion layer 9c in a junction-down system. As shown in FIG. 10, second ends of the wires 407d and 407f are connected to the metal layers 8b and 8c, respectively. As shown in FIGS. 10 and 11, second end of the wire 407h is connected to the n-side electrode 462.

Similarly to the aforementioned second embodiment (first embodiment), the red laser diode element 10 is formed to be operable by applying a voltage between the lead terminals 6a and 6b (lead terminal 6b is a positive potential). The blue laser diode element 420 is formed to be operable by applying a voltage between the lead terminals 406h and 406d (lead terminal 406d is a positive potential). The green laser diode element 430 is formed to be operable by applying a voltage between the lead terminals 406h and 406f (lead terminal 406f is a positive potential). The remaining structure of the third embodiment is similar to that of the aforementioned second embodiment.

According to the third embodiment, as hereinabove described, the blue and green laser diode elements 420 and 430 are formed as the monolithic blue and green two-wavelength laser diode element portion 460, whereby the common lead terminal 406h and wire 407h can be used with respect to the n-side electrode 462 of the blue and green laser diode elements 420 and 430, and hence the number of lead terminals and the number of wires can be reduced. Further, the number of wires is reduced and hence wire distribution can be simplified.

According to the third embodiment, the blue and green laser diode elements 420 and 430 are formed as the monolithic blue and green two-wavelength laser diode element portion 460, whereby the blue and green two-wavelength laser diode element portion 460 can be bonded to the surface of the heat radiation substrate 301d in a state where an interval between a luminous point of the blue laser diode element 420 and a luminous point of the green laser diode element 430 in the direction Y are further correctly positioned.

According to the third embodiment, the green and blue laser diode elements 430 and 420 are formed to have the common n-side electrode 462, whereby the green and blue laser diode elements 430 and 420 can be operated by connecting a common power supply to the n-side electrode 462 of the green and blue laser diode elements 430 and 420. The remaining effects of the third embodiment are similar to those of the aforementioned second embodiment.

### Fourth Embodiment

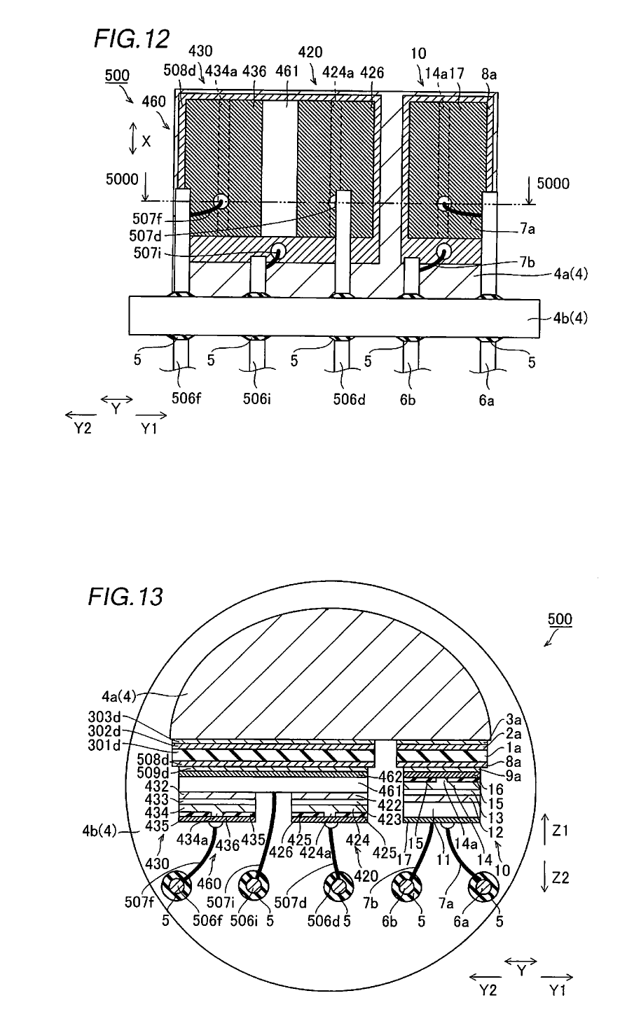

A fourth embodiment will be now described with reference to FIGS. 12 and 13. In a laser diode device 500 according to the fourth embodiment, blue and green laser diode elements 420 and 430 constituting a monolithic blue and green two-wavelength laser diode element portion 460 are bonded to a heat radiation substrate 301d in a junction-up system, dissimilarly to the aforementioned third embodiment.

In the laser diode device 500 according to the fourth embodiment of the present invention, lead terminals 6a, 6b, 506d, 506i and 506f are mounted successively from a Y1 side on a stem body 4b of a package 4, as shown in FIG. 12. First ends of wires 7a, 7b, 507d, 507i and 507f are connected to the lead terminals 6a, 6b, 506d, 506i and 506f, respectively.

According to the fourth embodiment, the blue and green laser diode elements 420 and 430 constituting the monolithic blue and green two-wavelength laser diode element portion 460 are bonded to the heat radiation substrate 301d in the junction-up system, as shown in FIG. 13. More specifically, a common n-side electrode 462 of the blue and green laser diode elements 420 and 430 is so bonded to a metal layer 508d formed on a surface of the heat radiation substrate 301d through a fusion layer 509d that p-side electrodes 426 and 436 of the blue and green laser diode elements 420 and 430 are located on an opposite side (Z2 side) to a support base 4a. Thus, the blue and green laser diode elements 420 and 430 are so bonded to the heat radiation substrate 301d that ridge portions 424a and 434a are located on an opposite side (Z2 side) to the heat radiation substrate 301d. Second ends of the wires 507d and 507f are connected to the p-side electrodes 426 and 436, respectively. As shown in FIG. 12, second end of the wire 507i is connected to the metal layer 508d.

The blue laser diode element 420 is so formed as to be operable by applying a voltage between the lead terminals 506d and 506i. The green laser diode element 430 is so formed as to be operable by applying a voltage between the lead terminals 506f and 506i. The remaining structure of the fourth embodiment is similar to that of the aforementioned third embodiment.

According to the fourth embodiment, as hereinabove described, the blue and green laser diode elements 420 and 430 constituting the blue and green two-wavelength laser diode element portion 460 are bonded to the heat radiation substrate 301d in the junction-up system, whereby the third light-emitting portion (portion of an active layer 423 on a lower portion (base portions) of a ridge portion 424a) of the blue laser diode element 420 and the second light-emitting portion (portion of an active layer 433 on a lower portion (base portions) of a ridge portion 434a) of the green laser diode element 430 can be kept away from the heat radiation substrate 301d in a direction Z2 as compared with a case of bonding in a junction-down system, and hence it is possible to reduce transmission of heat generated in the third and second light-emitting portions of the blue and green laser diode elements 420 and 430 to the red laser diode element 10 through the heat radiation substrate 301d, the package 4 and a heat radiation substrate 1a. Thus, deterioration of lasing characteristics resulting from rising temperature of the red laser diode element 10 can be further suppressed. The remaining effects of the fourth embodiment are similar to those of the aforementioned third embodiment.

Although the present invention has been described and illustrated in detail, it is clearly understood that the same is by way of illustration and example only and is not to be taken by way of limitation, the spirit and scope of the present invention being limited only by the terms of the appended claims.

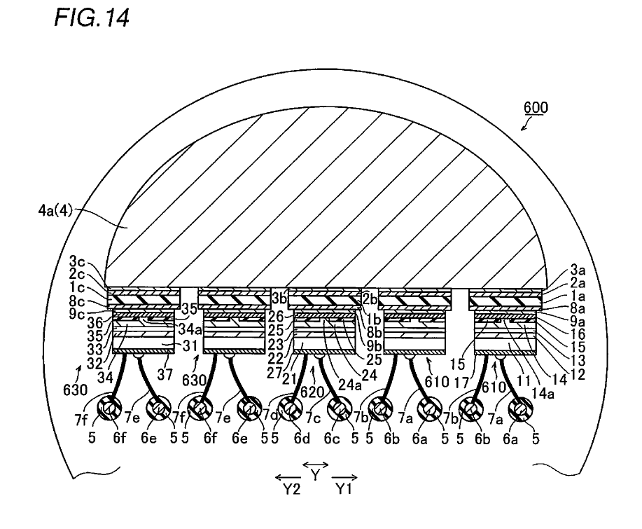

For example, while the laser diode device comprises the red laser diode element, the blue laser diode element and the green laser diode element in each of the aforementioned first to fourth embodiments, the present invention is not restricted to this but the laser diode device may comprise four or more laser diode elements. At this time, the red and green laser diode elements must be arranged so as not to be adjacent to each other. For example, as shown in FIG. 14, a red laser diode element 610, a red laser diode element 610, a blue laser diode element 620, a green laser diode element 630 and a green laser diode element 630 are arranged successively from a Y1 side on a support base 4a of a single package 4 to be lined up as in a laser diode device 600, so that the red laser diode elements 610 and the green laser diode elements 630 are arranged so as not to be adjacent to each other. Thus, it is possible to reduce transmission of heat from the green laser diode elements 630 where the large amount of heat is generated to a plurality of the red laser diode elements 610 arranged so as not to be adjacent to the green laser diode elements 630, and hence deterioration of lasing characteristics resulting from rising temperature of each of the red laser diode elements 610 during operation of the laser diode device 600 can be suppressed.

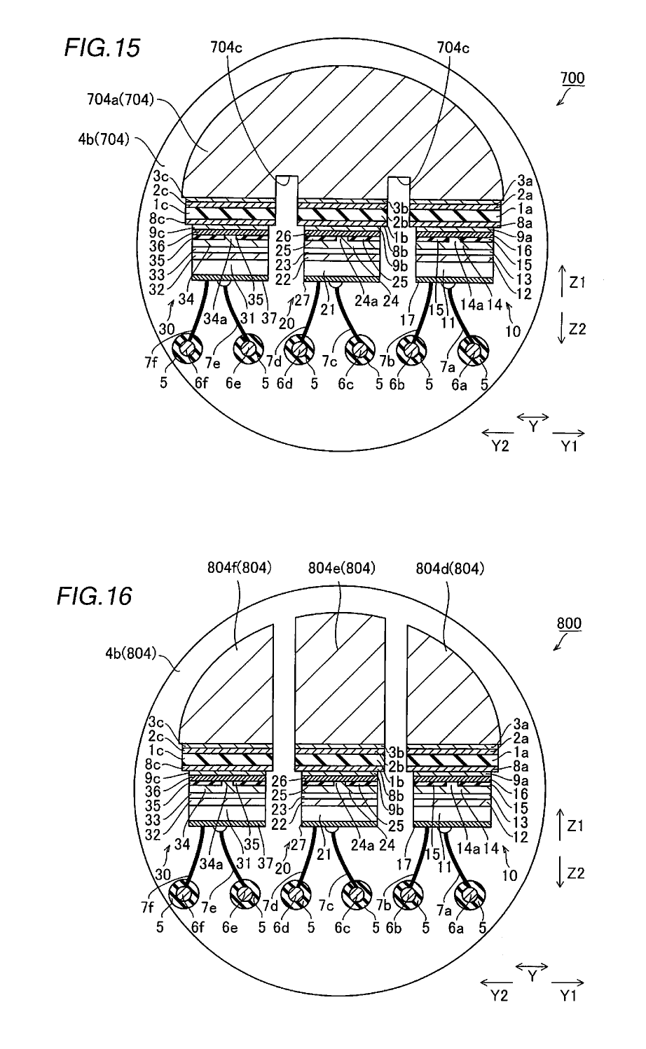

While the surface of the support base of the package on the heat radiation substrate side is planarized in each of the aforementioned first to fourth embodiments, the present invention is not restricted to this but grooves 704c may be provided between the heat radiation substrates 1a and 1b and between the heat radiation substrates 1b and 1c on a surface of a support base 704a of a package 704 on sides of the heat radiation substrates 1a, 1b and 1c as in a laser diode device 700 of FIG. 15, for example. Thus, it is possible to further reduce transmission of heat from the green and blue laser diode elements 30 and 20 to the red laser diode element 10 by the grooves 704c of the support base 704a.

While the surface of the support base of the package on the heat radiation substrate side is planarized in each of the aforementioned first to fourth embodiments, the present invention is not restricted to this but a support base of a package 840 is separated into support bases 804d, 804e and 804f for heat radiation substrates 1a, 1b and 1c, respectively, as in a laser diode device 800 of FIG. 16, for example. The support base 804d is an example of the “first support base” in the present invention, and the support bases 804e and 804f are examples of the “second support base” in the present invention. Thus, not only the heat radiation substrates 1a, 1b and 1c but also the support base 804d arranged with the heat radiation substrate 1a, the support base 804e arranged with the heat radiation substrate 1b and the support base 804f arranged with the heat radiation substrate 1c are separated from each other, and hence it is possible to further reduce transmission of heat from the green and blue laser diode elements 30 and 20 to the red laser diode element 10.

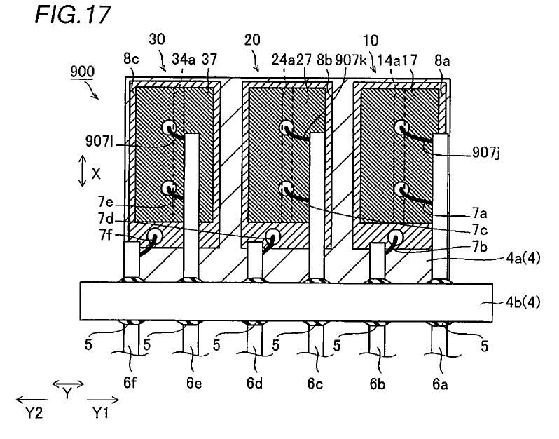

While the single wires are connected to the electrodes of red, green and blue laser diode elements 10, 20 and 30, on the opposite side to the support base in each of the aforementioned first to fourth embodiments, the present invention is not restricted to this but pairs of wires may be connected to the n-side electrodes 17, 27 and 37 of the laser device 100 according to the first embodiment in FIG. 1 by connecting the wires 7a, 7c and 7e to the n-side electrodes 17, 27 and 37 and connecting first ends of wires 907j, 907k and 907l to the n-side electrodes 17, 27 and 37 as in a laser diode device 900 of FIG. 17, for example. Thus, heat can be further radiated from the respective laser diode elements. Second ends of the wires 907j, 907k and 907l are connected to the lead terminals 6a, 6c and 6e, respectively. Three or more wires may be connected to the electrode of each laser diode element on the opposite side to the support base.

While the blue and green laser diode elements are bonded to the heat radiation substrates with growth substrates (the n-type GaN substrate and the n-type InGaN substrate) in each of the aforementioned first to fourth embodiments, the present invention is not restricted to this but the blue and green laser diode elements may be bonded to the heat radiation substrates after re-bonding to a support substrate made of Ge or the like and removing the growth substrates.

While the conductive support base and stem body constitute the package in each of the aforementioned first to fourth embodiments (except the modification of the first embodiment), the present invention is not restricted to this but the support base and the stem may be made of insulators having high thermal conductivity such as ceramics.

While the blue and green laser diode elements are formed by a nitride-based semiconductor layer such as AlInGaN or InGaN in each of the aforementioned first to fourth embodiments, the present invention is not restricted to this but the blue and green laser diode elements may be formed by a nitride-based semiconductor layer made of AlN, InN, BN, TlN or alloyed semiconductors thereof, having a wurtzite structure.

While the heat radiation substrate bonded with the red laser diode element and the heat radiation substrates bonded with the blue and green laser diode elements are different from each other in each of the aforementioned first to fourth embodiments, the present invention is not restricted to this but the heat radiation substrate bonded with the red laser diode element and the heat radiation substrates bonded with the blue and green laser diode elements may be a common heat radiation substrate.

While the red laser diode element is bonded to the heat radiation substrate in the junction-down system in each of the aforementioned first to fourth embodiments, the present invention is not restricted to this but the red laser diode element may be bonded to the heat radiation substrate in a junction-up system.

While the blue and green laser diode elements 420 and 430 constituting the monolithic blue and green two-wavelength laser diode element portion 460 are bonded to the heat radiation substrate in the junction-up system in the fourth embodiment, the present invention is not restricted to this but the respective blue and green laser diode elements may be bonded to the heat radiation substrate in the junction-up system. One of either blue or green laser diode element may be bonded to the heat radiation substrate in the junction-up system and the other of either blue or green laser diode element may be bonded to the heat radiation substrate in the junction-down system. In this case, the green laser diode element is preferably bonded to the heat radiation substrate in the junction-up system in view of the influence of heat transmitted to the red laser diode element.

While the blue and green laser diode elements 420 and 430 are bonded to the surface of the single heat radiation substrate 301d in the aforementioned third embodiment, the present invention is not restricted to this but the blue and green laser diode elements may be bonded to surfaces of two heat radiation substrates independently.

While the red and green laser diode elements are bonded in the vicinity of one end of the support base and in the vicinity of the other end, respectively, in each of the aforementioned first to fourth embodiments, the present invention is not restricted to this but the red and green laser diode elements may be bonded in the vicinity of the center of the support base. At this time, the blue laser diode element must be so arranged between the red and green laser diode elements that the red and green laser diode elements are not adjacent to each other.

While the case where the projector comprises the optical system having the liquid crystal panel and the case where the projector comprises the optical system having the DMD device are shown in the aforementioned first embodiment, the present invention is not restricted to this but the projector may be comprises modulation means such as an optical system having a scan mirror, for example.

What is claimed is:

1. A laser diode device comprising:
a red laser diode element;
a green laser diode element; and
a blue laser diode element, wherein
said red, green and blue laser diode elements are arranged in a package in a state of being independently connected to first, second and third wires for supplying power, respectively, and said blue laser diode element is arranged between said red laser diode element and said green laser diode element as viewed from a laser beam-emitting direction.

2. The laser diode device according to claim 1, wherein
said red laser diode element is formed on a GaAs substrate, and said green and blue laser diode elements are made of materials containing nitride-based semiconductors.

3. The laser diode device according to claim 1, wherein
said package has a support base arranged with said red, green and blue laser diode elements.

4. The laser diode device according to claim 3, wherein
said red laser diode element has a first light-emitting portion formed on a near side of said red laser diode element to said support base.

5. The laser diode device according to claim 3, further comprising:
a first heat radiation substrate arranged between said red laser diode element and said support base; and
at least one second heat radiation substrate arranged between said green laser diode element and said support base and between said blue laser diode element and said support base, wherein
said first heat radiation substrate is separated from said second heat radiation substrate.

6. The laser diode device according to claim 5, wherein
thermal conductivity of said first heat radiation substrate is higher than thermal conductivity of said second heat radiation substrate.

7. The laser diode device according to claim 5, wherein
said second heat radiation substrate includes a third heat radiation substrate arranged between said green laser diode element and said support base and a fourth heat radiation substrate, separated from said third heat radiation substrate, arranged between said blue laser diode element and said support base.

8. The laser diode device according to claim 5, wherein
said support base has a groove between a portion arranged with said first heat radiation substrate and a portion arranged with said second heat radiation substrate.

9. The laser diode device according to claim 5, wherein
said support base has a first support base arranged with said first heat radiation substrate and a second support base, separated from said first support base, arranged with said second heat radiation substrate.

10. The laser diode device according to claim 3, wherein
said green laser diode element and said blue laser diode element have a second light-emitting portion and a third light-emitting portion, respectively, and
said second and third light-emitting portions are formed on near sides of said green and blue laser diode elements to said support base, respectively.

11. The laser diode device according to claim 5, wherein
said package, said first heat radiation substrate and said second heat radiation substrate are conductive.

12. The laser diode device according to claim 3, wherein
said first, second and third wires are connected to respective electrodes of said red, green and blue laser diode elements on an opposite sides of said red, green and blue laser diode elements to said support base.

13. The laser diode device according to claim 1, wherein
said green and blue laser diode elements are formed on a surface of the same substrate.

14. The laser diode device according to claim 3, wherein
said red and green laser diode elements are arranged in the vicinity of one end of said support base and in the vicinity of the other end of said support base, respectively.

15. A laser diode device comprising:
a red laser diode element having a first light-emitting portion;
a green laser diode element having a second light-emitting portion;
a blue laser diode element having a third light-emitting portion; and
a package having a support base arranged with said red, green and blue laser diode elements, wherein
said blue laser diode element is arranged between said red laser diode element and said green laser diode element as viewed from a laser beam-emitting direction, and said first light-emitting portion, said second light-emitting portion and said third light-emitting portion are formed on near sides of said red, green and blue laser diode elements to said support base, respectively.

16. The laser diode device according to claim 15, further comprising:
a first heat radiation substrate arranged between said red laser diode element and said support base; and
at least one second heat radiation substrate arranged between said green laser diode element and said support base and between said blue laser diode element and said support base, wherein
said first heat radiation substrate is separated from said second heat radiation substrate.

17. The laser diode device according to claim 15, wherein
said support base has a groove between a portion arranged with said first heat radiation substrate and a portion arranged with said second heat radiation substrate.

18. The laser diode device according to claim 15, wherein
said support base has a first support base arranged with said first heat radiation substrate and a second support base, separated from said first support base, arranged with said second heat radiation substrate.

19. A display apparatus comprising:
a laser diode device including a red laser diode element, a green laser diode element and a blue laser diode element, wherein said red, green and blue laser diode elements are arranged in a package, and said blue laser diode element is arranged between said red laser diode element and said green laser diode element as viewed from a laser beam-emitting direction; and
means for modulating light from said laser diode device.

20. The display apparatus according to claim 19, wherein
said red, green and blue laser diode elements substantially simultaneously lase or alternately lase in time series.
